(19) United States
(12) Patent Application Publication
(10) Pub. No.: US 2010/0210330 A1
(43) Pub. Date: Aug. 19, 2010

(54) METHOD AND SYSTEM FOR A FANTASY SPORTS DRAFT GAME

(75) Inventor: Christopher Scott Fleming, Totowa, NJ (US)

Correspondence Address: LEWIS AND ROCA LLP, 1663 Hwy 395, Suite 201, Minden, NV, 89423, US

(73) Assignee: SPORTS DRAFT DAILY,LLC, Totowa, NJ (US)

(21) Appl. No.: 12/768,943

(22) Filed: Apr. 28, 2010

Related U.S. Application Data
(63) Continuation-in-part of application No. 12/326,258, filed on Dec. 2, 2008.

(51) Int. Cl. A63F 9/24; A63F 13/00

(52) U.S. Cl. 463/2; 463/42; 463/25; 463/30

(57) ABSTRACT

A fantasy sports game provides for a league of fantasy teams, each managed and owned by a fantasy game contestant. A contestant selects a set of games for a game day from a screen of such sets, pays an entry fee in points, and then drafts players from the teams playing in his selected set of games, subject to a salary cap for his team. As the games are being played and also after the games have been completed, the contestants playing against each other are ranked according to how well their players did that day, and the winning constant is awarded points for the win.

### CROSS-REFERENCE TO RELATED APPLICATIONS

This application is a continuation-in-part of co-pending U.S. patent application Ser. No. 12/326,258, filed Dec. 2, 2008, the entirety of which is incorporated by reference herein.

### BACKGROUND OF THE INVENTION

1. Field of the Invention

The present invention generally relates to online games and, more specifically, to a fantasy sports draft game.

2. The Prior Art

It is estimated by the Fantasy Sports Trade Association that 29.9 million people age 12 and above in the U.S. and Canada played fantasy sports in 2007. A prior study by the FSTA showed 19.4 million people age 12 and above in the U.S. and Canada played fantasy sports in 2006 and 34.5 million people had ever played fantasy sports. A 2006 study showed that 22 percent of U.S. adult males 18 to 49 years old, with Internet access, played fantasy sports. Fantasy sports are estimated to have a $3-$4 Billion annual economic impact across the sports industry. Fantasy sports are also popular throughout the world with leagues for football (known as soccer in the United States), cricket and other non-U.S. based sports.

The concept of picking players and running a contest based on their year-to-date stats has been around since shortly after World War II, but was never organized into a widespread hobby or formal business. In 1960, Harvard University sociologist William Gamson started the “Baseball Seminar” where colleagues would form rosters that earned points on the players' final standings in batting average, RBI, ERA and wins. Gamson later brought the idea with him to the University of Michigan where some professors played the game. One professor playing the game was Bob Sklar, who taught an American Studies seminar which included Daniel Okrent, who learned of the game his professor played. At around the same time a league from Glassboro State College also formed a similar baseball league and had its first draft in 1976.

While those two leagues focused on baseball, it may be football that produced the first version of the hobby. The Greater Oakland Professional Pigskin Prognosticators League—began in the early '60s with eight teams and included a cadre of Raiders followers from the media and ticket office—including future league executives Scotty Stirling and Ron Wolf.

The landmark development in fantasy sports may have come with the development of Rotisserie League Baseball in 1980. Magazine writer/editor Daniel Okrent is typically credited with inventing it, the name coming from the New York City restaurant La Rotisserie Francaise where he and some friends used to meet and play. The game's innovation was primarily that “owners” in a Rotisserie league would draft teams from the list of active Major League Baseball players and would follow their statistics during the ongoing season to compile their scores. In other words, rather than using statistics for seasons whose outcomes were already known, the owners would have to make similar predictions about players' playing time, health, and expected performance that real baseball managers must make.

Because Okrent was a member of the media, other journalists, especially sports journalists, were introduced to the game. Many early contestants were introduced to the game by these sports journalists, especially during the 1981 Major League Baseball strike; with little else to write about, many baseball writers wrote columns about Rotisserie league. A Jul. 8, 1980 New York Times Article titled “What George Steinbrenner is to the American League, Lee Eisenberg is to the Rotisseries League” set off a media storm that led to stories about the league on CBS TV and other publications.

In March 1981, Dan Okrent wrote an essay about the Rotisserie League for Inside Sports called “The Year George Foster Wasn't Worth $36.” The article included the rules of the game. Founders of the original Rotisserie league published a guide book starting in 1984. In 1982, Ballantine published the first widely-available Bill James Abstract, which helped fuel fantasy baseball interest. Fantasy fans often used James' statistical tools and analysis as way to improve their teams. James was not a fantasy contestant and barely acknowledged fantasy baseball in his annual Abstract, but fantasy baseball interest is credited with his strong sales. Soon the hobby spread to other sports as well and by 1988, USA Today estimated that five hundred thousand people were playing.

In the few years after Okrent helped popularize fantasy baseball, a host of experts and business emerged to service the growing hobby. Okrent, based on discussions with colleagues at USA Today, credits Rotisserie League baseball with much of USA Today's early success, since the paper provided much more detailed box scores than most competitors and eventually even created a special paper, Baseball Weekly, that almost exclusively contained statistics and box scores.

Among the first high-profile experts were John Benson, Alex Patton and Ron Shandler. Benson became perhaps the most famous name in the business in the late 1980s, publishing his first book in 1989 and developing one of the first draft-software simulation programs. He had a 900 number at $2.50 per minute (or $150 per hour) in the mid 2000s.

Patton published his first book (“Patton's 1989 Fantasy Baseball League Price Guide”) in 1989 and his dollar values were included in USA Today Baseball Weekly's fantasy annual throughout the 1990s.

Ron Shandler published his “Baseball SuperSTATS” book in November 1986. At first the book wasn't meant for fantasy baseball fans, but rather as a book of Sabrmetric analysis.

But it wasn't just baseball that saw new businesses and growth. Fantasy Football Index became the first annual fantasy football guide in 1987. Fantasy Sports Magazine debuted in 1989 as the first regular publication covering more than one fantasy sport. Fantasy Football Weekly was launched in 1992 (later becoming Fanball.com) and had $2 million in revenue by 1999. A large number of companies emerged to calculate the stats for fantasy leagues and primarily sent results to subscribers via fax.

In 1993, USA Today included a weekly columnist on fantasy baseball, John Hunt, and he became perhaps the most visible writer in the industry before the rise of the Internet. Hunt started the first high-profile experts league, the League of Alternate Baseball Reality which first included notables as Peter Gammons, Keith Olbermann, and Bill James. The hobby continued to grow with 1 million to 3 million playing from 1991 to 1994.

But the seminal moment for the growth of fantasy sports was probably the rise of the Internet in the mid-1990s. The new technology lowered the barrier to entry to the hobby as stats could quickly be compiled online and news and information became readily available.

While several fantasy businesses had migrated to the Internet in the mid-1990s, the watershed era for online fantasy sports was arguably in 1997 when two web sites made their debut that forever changed the fantasy sports industry: Commissioner.com and RotoNews.com.

Commissioner.com launched in Jan. 1, 1997 and first offered a fantasy baseball commissioner service that changed the nature of fantasy sports with real-time stats, league message boards, daily updated box scores, and other features—all for $300 per league. Commissioner.com was sold to Sportsline late in 1999 for $31 million in cash and stock in a significant moment for the fantasy industry. The sale proved fantasy sports had grown from a mere hobby to big business. By 2003, Commissioner.com helped Sportsline generate $11 million from fantasy revenue. Commissioner.com is now currently the fantasy sports engine behind CBSsports.com's fantasy area (after Sportsline was sold to CBS).

RotoNews.com also launched in January 1997 and published its first player note on Feb. 16, 1997. RotoNews arguably revolutionized how fantasy sports information was presented on the web with the innovation of the “player notes” which are snippets of information every time a player got hurt, traded, benched or had a news event that impact his fantasy value—all search-able in real-time databases. Many sites today follow how RotoNews had a “news” and “analysis” element to each player update. Within two years, RotoNews had become one of the top ten most trafficked sports sites on the web, according to Media Metrix, ranking higher than such sites as NBA.com. RotoNews.com was sold to Broadband Sports in 1999 and later survived as RotoWire.com.

It wasn't long before the larger media players got involved. Yahoo.com added fantasy sports in 1999 and offered most of its games for free—a largely new business model for fantasy sports. A trade group for the industry, the Fantasy Sports Trade Association (FSTA), was formed in 1998. Other entries during this era included Fanball.com, launched in 1999 by the parent company of Fantasy Football Weekly.

The first survey of the fantasy sports market in the U.S. in 1999 showed 29.6 million people age 18 and older played fantasy sports games. However, that figure was corrected in later years when it was determined the survey also included people who played NCAA bracket pools, which are not exactly fantasy sports (where individual players are picked).

There were also wide variations on business models. RotoNews.com launched the Web's first free “commissioner” service in 1998, quickly becoming the largest league management service. Yahoo.com became the first major media company to offer games for free in 1999. Due to the rising competition, Commissioner.com, which had charged as much as $300, offered its commissioner services for free starting with football in 2000. Two years later the trend reversed. Sportsline moved back to a pay model for commissioner services (which it largely still has today). TheHuddle.com, a free site since 1997, started to charge for information. RotoWire.com moved from a free model to a pay model in 2001 as well.

Despite the economic instability, fantasy sports started to become a mainstream hobby. In 2002, the NFL found that the average male surveyed b spent 6.6 hours a week watching the NFL on TV, but that fantasy sports players surveyed said they watched 8.4 hours of NFL per week. The NFL began running promotional television ads for fantasy football featuring current players for the first time. Previously, fantasy sports had largely been seen in a negative light by the major sports leagues.

Fantasy sports continued to grow with a 2003 FSTA survey showing 15 million people playing fantasy football and spending about $150 a year on average, making it a $1.5 billion industry. With the growth of the industry, fantasy has branched out to include non-sports related games focused on politics, celebrity gossip, movies, and reality TV. Notable games in these new categories include:

Fantasy Congress

Fantasy Mogul

As noted above, Fantasy baseball is one of the most popular fantasy sports. The following describes some variations of fantasy baseball in more depth. Note though that this is illustrative only. There are other methods of play and other fantasy sports.

Fantasy baseball is a game whereby fantasy game contestants manage imaginary baseball teams based on the real-life performance of baseball players, and compete against one another using those players' statistics to score points. It is probably the oldest form of fantasy sports, and arguably one of the most difficult and time-intensive due to the 162-game season of the MLB and the inconsistency of players.

Rotisserie Leagues and their descendants typically draft teams before the season begins (or very shortly thereafter). One approach is to hold an auction, whereby each owner or manager has a fixed amount of money to bid for players, and he must fill his team's roster within his budget. Another approach is to perform a serpentine system draft of available players until all teams are filled.

In either case, the skills of the fantasy team managers come into play in the “preseason” by their knowledge of the talent and ability to forecast the performance of Major League Baseball players and prospects for the coming season. Toward that end, they draw on a great variety of sources of information, including tout sheets by various forecasters, who predict the coming season's performance and the likely overall “value” (often in terms of auction dollars) of the Major League players.

Some leagues allow teams to keep some players from one year to the next, allowing savvy owners to build fantasy dynasties. These leagues are often referred to as “Keeper Leagues.” Keeper leagues typically have the same people in them, and owners keep their players, unless any off-season moves are made.

Many leagues allow teams to trade with each other during the season, as well as to replace players who get hurt or stop performing well with players from the pool of those who are not presently owned. However, some leagues prohibit such in-season “free agent” replacements, likely feeling that the game is more interesting when teams must live and die by the quality of their draft.

Also, at a league's discretion, there are typically only a limited number of free-agent moves that a fantasy team can make per season, and a team may not just “drop” all of their players if they are not progressing well during a season. The free-agent limit is also sometimes used to limit the so-called “pitch-and-ditch” tactic, a method of play in which a manager drafts a free agent pitcher with the intention of using him in only one game before replacing him with a pitcher who is scheduled to start the following day.

Many fantasy leagues are played for money. “Owners” ante up an entry fee at the beginning of the season and may also be charged for in-season activity such as trades and “free agent” acquisitions. The pool of money is collected and then distributed to the winner(s) at the end of the season. In some cases though, these are games in which the main reward is bragging rights or the participants' sense that they not only know how to assess baseball talent but also how to play the fantasy game in all of its dimensions including perhaps above all the selection of real baseball talent.

The statistics compiled by the players from each team are then ranked by category, and the team with the highest cumulative rank at the end of the season is determined to be the winner.

The original Rotisserie League used the following statistics:

team batting average (total hits divided by total at-bats)

total home runs

total runs batted in

total stolen bases

total wins

total saves

team earned run average (9 times total earned runs divided by total innings pitched, the lower the better)

team WHIP (total number of hits and walks allowed by pitchers divided by total innings pitched, the lower the better)

This is often called a “4×4” league (4 hitting stats and 4 pitching stats). Many leagues have adopted a “5×5” format, with runs and strikeouts (as a pitching statistic) added, respectively. Still other leagues have adopted a “6×6” format, most commonly adding OPS (OBP plus SLG), and holds. However, the “6×6” format does not yet have a standard or consensus set of categories to use. Other modifications to the rules include a minimum number of at-bats and innings pitched; teams that do not make the minimum were awarded last place in the respective categories.

An alternative head-to-head system provides that each team competes against only one team each week. At the end of the week, each team tallies wins and losses based on whatever criteria are set by the league. Below are three exemplary basic forms of head-to-head leagues (often referred to as “H2H”):

Head-to-Head Rotisserie: Wins, losses and ties are based on a team's performance in individual categories.

Head-to-Head One Win: Just like H2H Rotisserie, but the winner receives just one win, rather than one win for each category the team wins.

Head-to-Head Points: Stats accumulate points for each team (a Home Run/Stolen Base/etc. is worth a certain number of points), and the team with the most points at the end of the week is awarded a win. These leagues often take advantage of several other statistical categories, from outfield assists to quality starts.

Opponents are often dictated by a round-robin system. At the end of the season, the team with the best win-loss record is the victor. Many head-to-head leagues also feature playoffs over the last 3-4 weeks of the MLB regular season. A set number of teams make the “postseason” and play a single-elimination tournament to decide a victor.

While there is still a lot of enthusiasm for the present methods of fantasy sports gaming, a better, more challenging method of fantasy gaming would be advantageous.

### BRIEF SUMMARY OF THE INVENTION

A fantasy sports game provides for a league of fantasy teams, each managed and owned by a fantasy game contestant. A contestant selects a set of games for a game day from a screen of such sets, pays an entry fee in points or cash, and then drafts players from the teams playing in his selected set of games, sometimes subject to a salary cap for his team. After the games have been played, the contestants playing against each other are ranked according to how well their players did that day, and the winning constant is awarded points or cash for the win.

### BRIEF DESCRIPTION OF THE DRAWINGS

FIG. 1 is a block diagram illustrating an exemplary system, in accordance with one embodiment of the present invention;

FIG. 2 is a flow chart illustrating an example of the game play in accordance with one embodiment of the present invention;

FIG. 3 is a flowchart illustrating drafting players within a salary cap, in accordance with the embodiment shown in FIG. 2;

FIG. 4 is an exemplary computer screen illustrating game selection in one embodiment of the present invention;

FIG. 5 is an exemplary computer screen illustrating player drafting in accordance with the embodiment and example shown in FIG. 4;

FIG. 6 is an exemplary computer screen illustrating contestant results in accordance with the embodiment and example shown in FIGS. 4 and 5; and

FIG. 7 is a block diagram illustrating a General Purpose Computer 20, such as utilized for the server and personal computers shown in FIG. 1.

### DETAILED DESCRIPTION OF THE INVENTION

The present invention conducts fantasy sports drafts for baseball, football, basketball, hockey, soccer, NASCAR, golf, and other sports by using the stats for a single day's game or games. The present invention includes drafting professional players as well as amateurs, such as college competitors. Current fantasy sports leagues are typically conducted by holding either live or online drafts where a fantasy game contestant acting as an owner/manager picks players based on projected stats and then manages those players throughout the regular season to accumulate the stats that they derive in real life. Henceforth, the terms “contestant”, “owner”, “manager” and “fantasy game player” will be used interchangeably. One key difference in the present invention is that one day's or one game's statistics are utilized. This provides a mechanism for much quicker turn-around from drafting to determining whether the manager/contestant won or lost in competition with other manager/contestants.

Applicants believe that what draws people the most to these games is the initial player “draft”. The actual managing of the fantasy teams post-draft is often cumbersome and based on some degree of luck in determining winners over losers. In one embodiment of this invention, the game provides for fantasy game contestants arriving at a website online and conducting a normal draft, just like the ones they are accustomed to in the prior art, but instead of drafting based for the entire season, they would be only drafting for a single day or game. In one embodiment, multiple contestants can draft the same players. In another embodiment, there could for example be a draft order randomly selected by a computer for each participant, numbered 1-12. The draft could then be conducted in a serpentine fashion, 1-12, 12-1, 1-12, etc. Other selection and draft methodologies are also within the scope of the present invention, including randomizing each round of the draft.

In one embodiment of the present invention, there are roster requirements that each team will have to fulfill for each game. These roster requirements may vary from game to game, depending on the embodiment. As a further example: in baseball there may be 8 hitters: 1 Catchers, 1 First Baseman, 1 Second Baseman, 1 Third Baseman, 1 Shortstop, and 3 Outfielders. On the pitching side there would be 2 slots that could be made up of starting and relief pitchers to the contestants choosing, allowing for varying strategies. The positions must be filled in order to have a legal fantasy team and in contests containing a salary cap, the salaries of the players that you choose must not exceed the cap limit. Alternatively, a smaller roster may be utilized. Other team organizations would also be within the scope of the present invention.

In one embodiment, teams are scored based on the scoring of the players. In another embodiment, the statistical categories that would be used for scoring the fantasy game are: batting average; home runs; runs batted in; runs scored; and stolen bases for the hitters, and wins; strikeouts; saves; earned run average; and walks+hits per inning pitched for the pitchers. Collectively there would be 10 categories that a contestant can earn points in and each are assigned a point total in this embodiment. For example, in this embodiment: the team that accumulates the most points for the stats their players accrue would be determined the winner of that contest. The “total points” each fantasy team attains in “each category” would be added together to arrive at their “total score.”

In one embodiment, assuming 10 contestants and teams, one goal of the game would be to draft a team that will accumulate the most points overall for that one days games versus the other 9 teams. After all 10 teams have selected the 10 (or potentially fewer or greater number) required players, those players stats from real life in that days games would be credited to each teams roster in the fantasy contest, and a winner would be determined based on which team accumulated the most points for that day, as well as, a ranking of the 10 fantasy teams in order of point accumulation after the completion of the actual games. One advantage, compared to the prior art, is that a winner is determined at the conclusion of the sporting games for that one day. So instead of drafting players in March and managing them over the course of the next six months to determine a winner; the unknowns, such as player injuries, free agent bidding, and unfair trades (the luck aspects in the prior art) are removed and replaced with quicker gratification based on the skill level of the drafters and how their players perform in one day compared to the whole season. Another advantage is that people can play this game everyday of a particular sports season, or potentially even multiple times per day. Draft Day, the favorite part of many fantasy sports competitors, is now available perpetually.

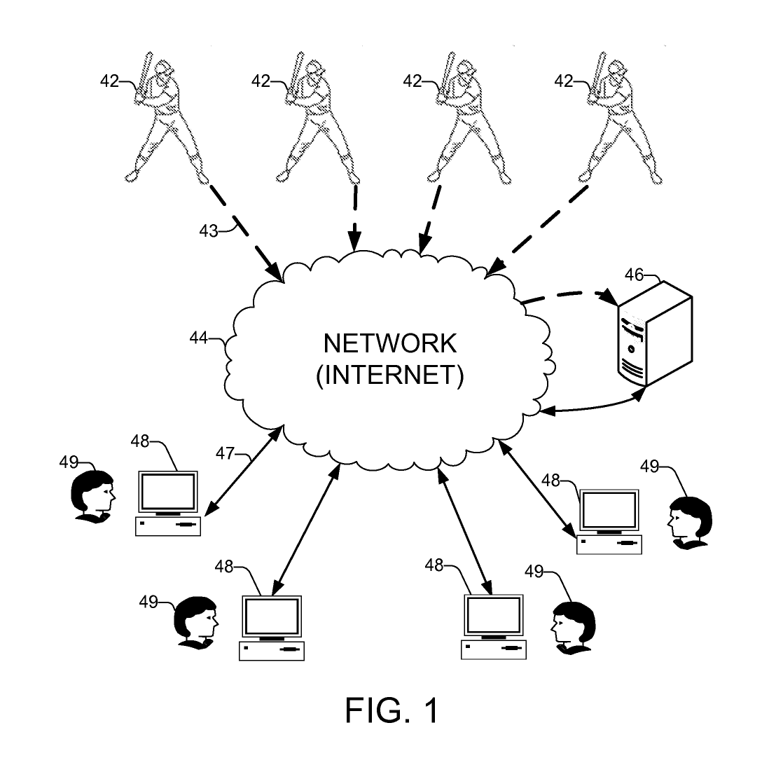

FIG. 1 is a block diagram illustrating an exemplary system, in accordance with one embodiment of the present invention. This embodiment utilizes baseball as the fantasy sport, but other sports are also within the scope of this invention. Multiple baseball games 42 are played, and their statistics transmitted to 43 and accumulated on a server 46. In this embodiment, the entire play of Major League Baseball (MLB) or one of its two leagues is utilized for these statistics. Alternatively, the statistics can be accumulated by other parties and acquired from them. The statistics will typically be collected for a short period, for example, a single day. In this illustration, the transmission is shown across a network, in this example, the Internet 44. Fantasy game contestants (the fantasy team managers) 49, in this example utilizing their computers 48, join a fantasy league run on the server 46. Alternatively, they may utilize conferencing, and in particular, on-line conferencing, to make their draft picks. During and at the end of the play period, software on the server 46 is utilized to rank the fantasy teams in the fantasy league. In one embodiment of the present invention, the fantasy contestant interface is web based, utilizing web browsers running on their computers 48 to communicate 47 across the Internet 44 with the fantasy game running as a web server application on the server 46. Other interfaces and system architectures are also within the scope of the present invention.

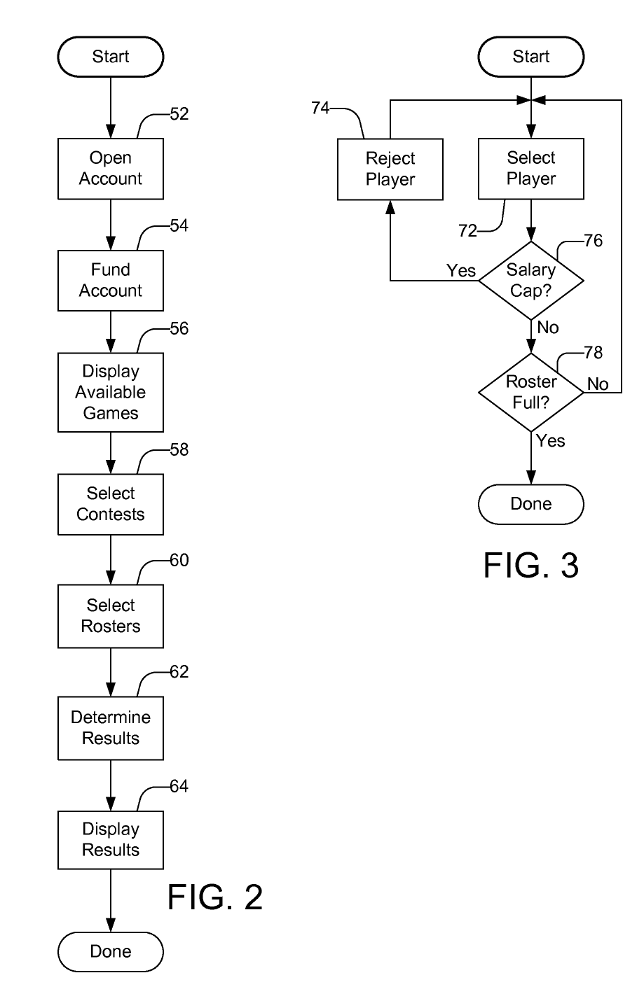

FIG. 2 is a flow chart illustrating an example of game play in accordance with one embodiment of the present invention. The contestant opens an account, step 52, if not already open. In one option, the account is funded, if necessary, step 54, typically through payment by a credit card, PayPal, or other online mechanism. In one embodiment, contestants are debited for a selected or a fixed amount for each game played. In one embodiment, the contestants may earn points by winning games that may be applied to the cost of playing subsequent games. Also, in one embodiment, contestants may play for free in certain games and/or in certain circumstances. Free play may be funded through online advertising or through other mechanisms.

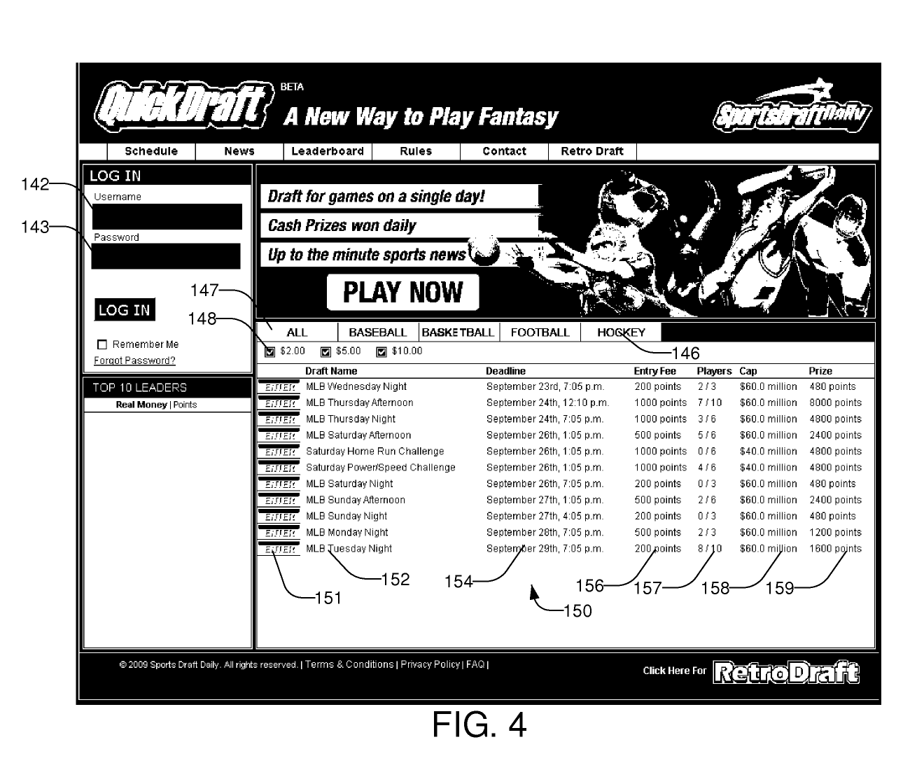

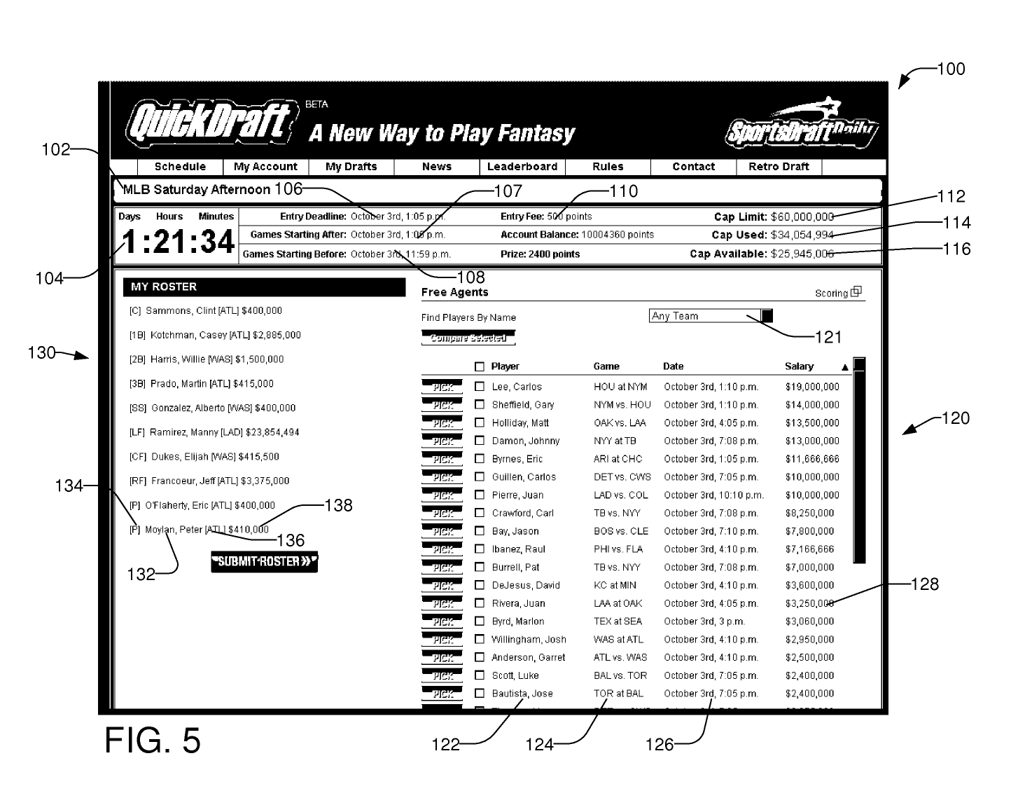

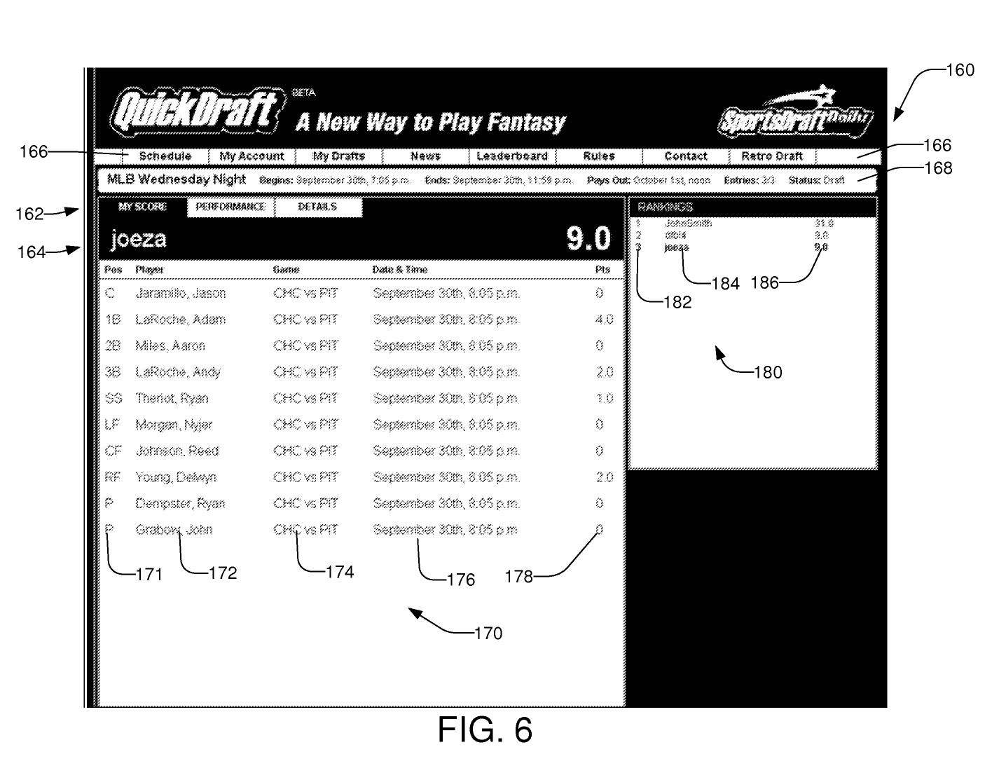

A contest schedule may be displayed showing available games, step 55 (see FIG. 4). The contestant then may select a contest compete in, step 58. After selecting a contest, the contestant then may fill his roster, step 60, for the games on the selected day or days (see FIG. 5). After the games have been played on that day or days, the results from the contestant's team are analyzed, step 52, and displayed to the contestant 54 (see FIG. 6). In one embodiment, the contestant is considered a winner if the selected players on his team scored more points than the players of his opponents did that day. Other criteria for winning are also within the scope of the present invention.

FIG. 3 is a flowchart illustrating drafting players within a salary cap, in accordance with the embodiment shown in FIG. 2. A player is selected, step 72. A check is made whether the salary cap is exceeded, step 76. If the salary cap would be exceeded by selecting this player, step 76, the selection is rejected, step 74. A check is made whether the roster for the contestant's team is full, step 78, and if it is not full, then the steps are repeated, starting at the selection of a player, step 72. Other methods of drafting players are also within the scope of the present invention. For example, a salary cap may not be utilized.

In one example of an embodiment of the present invention, the NFL season begins. Each Sunday, a certain number of games are played. The schedule of these games are displayed, and the players on the teams playing those days will be displayed, listed by position. A team is then selected from those players playing on a game day. The drafting may utilize a salary cap, or it may not. Assuming a salary cap, the contestant may select player X as a quarterback at a salary of $4.0 million, and then player Y as a running back at a salary of $6.6 million. If the roster requires one quarterback, two running backs, and two wide receivers for this game, and carried a salary cap of $20 million per team, the contestant would have $9.6 million left to spend on the remaining running back and two wide receivers. In one embodiment, once a roster is selected, it may be adjusted at any time up to the start of the first game of the day.

When the games for that day begin, contestants' teams are credited with the performance of the players selected, for example, in a simple point-style format (see FIG. 6). Other methods of scoring are also within the scope of the present invention. The scores are preferably viewable in real-time, live on the website or handheld device, for all the teams in a given contest. At the end of the last game in the contest, the contestant with the team with the most total points may then be declared the winner of the contest.

In one embodiment of the present invention, players may be drafted by more than one contestant in a contest. This applies whether or not a salary cap is utilized. Players can be dropped and others substituted up until the start of the first game in the contest. In another embodiment, the contestants initially rotate turns drafting in, for example, a serpentine fashion.

FIG. 4 is an exemplary computer screen illustrating game selection in one embodiment of the present invention. The screen 140 has a “log in” section that allows a contestant to input his username 142 and password 143. There is a “remember me” selection box that allows the browser to remember the contestant's username and optionally password for subsequent sign-ons to the system, typically through the use of cookies. If the contestant does not currently have an account, he will typically be required to create one before being allowed to play. There may be a set of tabs 146 that identify different fantasy sports that may be played. In this example, there are tabs for: Baseball; Basketball; Football; and Hockey. Other sports are also within the scope of the present invention. There is also an “All” tab 147 that displays all games open for play. Otherwise, if the contestant selects one of the sports tabs, such as “Baseball”, only contests involving the selected game type are displayed. There are also check boxes 148 for selecting different game prices. In this example, boxes for $2, $5, and $10 are shown and checked. In this embodiment, these correspond to the number of points required to play a game, with one penny corresponding to one point. Thus, a $2 game requires 200 points to play. Other arrangements and combinations are also within the scope of the present invention.

Once the game tab 146 and game prices 148 are selected, a list of games 150 is displayed. For each game displayed, there is an “Enter” button 151, the name of the game 152, the deadline for entering the game 154, the entry fee in points 156, the number of contestants 157 allowed and signed up, the salary cap for that game 148, and the number of points that can be won playing that game 159. Thus, for example, the last game shown is titled “MLB Tuesday Night”, has a deadline of September 29 at 7:05 p.m. It costs 200 points to play, and 8 out of 10 possible contestant slots are already full. The salary cap is $60 million and the contestant who wins the game wins 1600 points. It should be noted that the Prize for any game is typically lower than the entry fee multiplied times the number of contestants allowed into the game. In this example, the prize is 80% of the total points required by the contestants to play. This provides a mechanism to force the universe of contestants to continue to have to pay to play. Other ratios are also within the scope of the present invention, as well as other mechanisms for making such an invention profitable.

FIG. 5 is an exemplary computer screen illustrating player drafting in accordance with the embodiment and example shown in FIG. 4. The screen 100 has a game title 102 at the top of the screen. This is the name of the game 152 selected in FIG. 4. On the very left at the top of the screen is the remaining time until the game starts (and drafting is terminated) 104. Also at the top of the screen on the left are displayed for the selected game: entry deadline 106, game starting after date and time 107, and game starting before date and time 108. Displayed in the middle at the top of the screen are the entry fee number of points 110, account balance, and prize number of points. Displayed on the right side at the top of the screen are displayed the salary cap 112, cap used 114, and cap still available 116. Down the left hand side of the lower portion screen are listed the players already selected 130. For each selected player, his name 132, position 134, team 136, and salary 138 are displayed. On the right side of the lower portion of the screen are displayed the unselected players 120. Displayed for each undrafted player are his: name 122, game in which he is playing 124, date and time he is playing 126, and his salary 128. Alternatively, his team may be displayed. Also, in this example, there is a pull down menu 121 that allows selection of players from all teams, or from specific teams.

FIG. 6 is an exemplary computer screen illustrating contestant results in accordance with the embodiment and example shown in FIGS. 4 and 5. The screen 160 shows the player's name 164 and the name of the game played 166. There are tabs 162 for selecting “My Score”, “Performance”, and “Detail”. Other tabs are also within the scope of the present invention. In this example, the “My Score” tab has been selected, and the results of a contestant named “joeza” are displayed. A list of the players drafted and their results 170 is displayed. For each player drafted, his position 171, name 172, the game in which he played 174, date and time of game 176, and points scored 178 are displayed. The contestant's score (e.g. “9.0”) is displayed. There is also a section that shows the results 180 for all the contestants in that game. The ranking 182, user name 184, and score 186 are shown for each contestant. In this game 166, the results for three contestants are shown: JohnSmith with 31 points; #2 dfol4 with 9.0 points; and #3 joeza with 9.0 points.

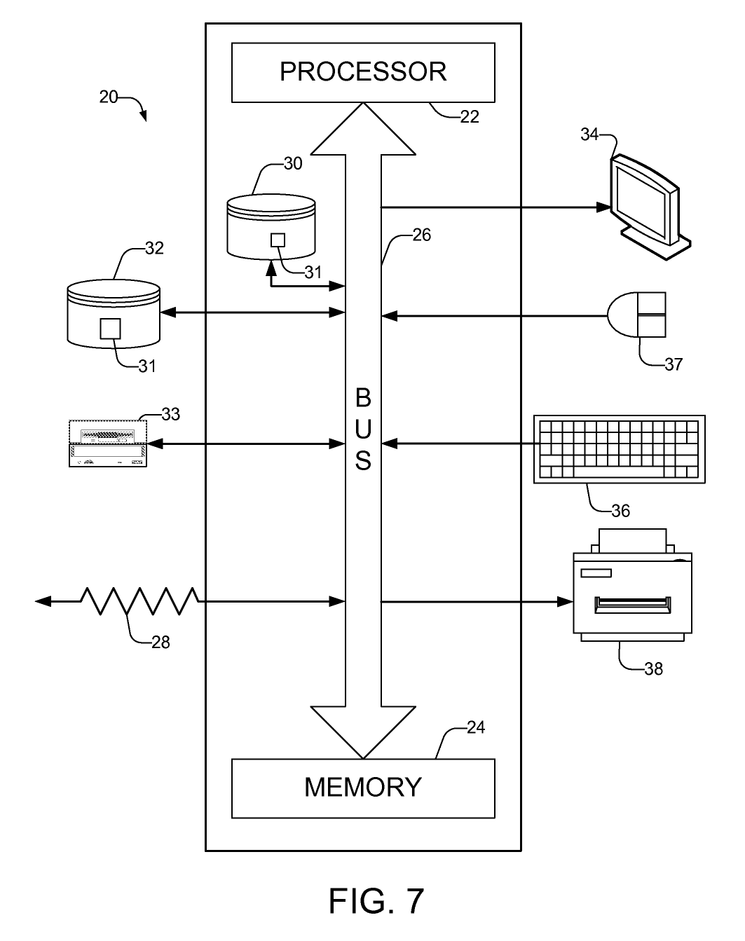

FIG. 7 is a block diagram illustrating a General Purpose Computer 20, such as utilized for the server 46 and personal computers 48 shown in FIG. 1. The General Purpose Computer 20 has a Computer Processor 22 (CPU), and Memory 24, connected by a Bus 26. Memory 24 is a relatively high speed machine readable medium and includes Volatile Memories such as DRAM, and SRAM, and Non-Volatile Memories such as, ROM, FLASH, EPROM, EEPROM, and bubble memory. Also connected to the Bus are Secondary Storage 30, External Storage 32, output devices such as a monitor 34, input devices such as a keyboard 36 with a mouse 37, and printers 38. Secondary Storage 30 includes machine-readable media such as hard disk drives, magnetic drum, and bubble memory. External Storage 32 includes machine-readable media such as floppy disks, removable hard drives, magnetic tape, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such operating systems, utilities, user programs, and fantasy game and statistics collection software can be stored in a Computer Software Storage Medium, such as memory 24, Secondary Storage 30, and External Storage 32. Executable versions of computer software 33, such as defragmentation software and operating systems can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution.

Those skilled in the art will recognize that modifications and variations can be made without departing from the spirit of the invention. Therefore, it is intended that this invention encompass all such variations and modifications as fall within the scope of the appended claims.

What is claimed is:

1. A method of fantasy gaming comprising:
providing a selected contest comprising a plurality of teams as a selected plurality of teams playing in a selected plurality of sporting games utilizing a computer system;
providing a roster of available players from the selected plurality of teams as a plurality of potential draft picks utilizing a computer system;
for each contestant in a plurality of contestants in the selected contest as an identified contestant:
receiving a plurality of draft picks from the identified contestant to form a team from the potential draft picks for the identified contestant from an input device coupled to the computer system;
receiving results from the selected plurality of sporting games by the computer system;
calculating results for each of the contestants in the selected contest utilizing the computer system based on results from the selected plurality of sporting games for the players on the teams selected by each of the contestants in the selected contest;
sorting the results for each of the contestants in the selected contest utilizing the computer system; and
selecting a winner from the plurality of contestants of the selected contest based on the results of each of the contestants utilizing the computer system.

2. The method in claim 1 which further comprises:
providing a selection of a plurality of contests to contestants on the display device; and
accepting a selection of one of the plurality of contests as the selected contest from an input device.

3. The method in claim 1 wherein:
at least two of the contestants in the plurality of contestants can draft a same player.

4. The method in claim 1 wherein:
only one of the contestants in the plurality of contestants can draft a player; and
the contestants take turns drafting players for their teams.

5. The method in claim 1 wherein:
each player in the plurality of potential draft picks has a salary; and
each contestant in the plurality of contestants has a salary cap under which the salaries of the players on that contestant's team must fit.

6. The method in claim 1 wherein:
each of the sporting games in the plurality of sporting games in the selected contest is scheduled to be played within a short time period.

7. The method in claim 6 wherein:
the short time period is a single day.

8. The method in claim 1 wherein:
the plurality of sporting games in the selected contest are each a same one of a set comprising: football, baseball, basketball, ice hockey, soccer, NASCAR, rugby, golf, and tennis.

9. The method in claim 1 wherein:
the method further comprises:
collecting an entry fee from each of the contestants in the selected contest; and
the winner is awarded a prize comprising at least one of a predetermined number of points and a predetermined amount of money for winning the selected contest.

10. The method in claim 1 wherein:
calculating results for each of the contestants includes determining how many points each of the players on each of the teams scored in the plurality of sporting games.

11. A system for providing fantasy sports gaming comprising:
a processor; and
a memory containing instructions executable by the processor for:
providing a selected contest comprising a plurality of teams as a selected plurality of teams playing in a selected plurality of sporting games utilizing a computer system;
providing a roster of available players from the selected plurality of teams as a plurality of potential draft picks utilizing a computer system;
for each contestant in a plurality of contestants in the selected contest as an identified contestant:
receiving a plurality of draft picks from the identified contestant to form a team from the potential draft picks for the identified contestant from an input device coupled to the computer system;
receiving results from the selected plurality of sporting games by the computer system;
calculating results for each of the contestants in the selected contest utilizing the computer system based on results from the selected plurality of sporting games for the players on the teams selected by each of the contestants in the selected contest;
sorting the results for each of the contestants in the selected contest utilizing the computer system; and
selecting a winner from the plurality of contestants of the selected contest based on the results of each of the contestants utilizing the computer system.

12. The system in claim 11 which further comprises:
providing a selection of a plurality of contests to contestants on the display device; and
accepting a selection of one of the plurality of contests as the selected contest from an input device.

13. The system in claim 11 wherein the memory further contains instructions for:
at least two of the contestants in the plurality of contestants can draft a same player.

14. The system in claim 11 wherein the memory further contains instructions for:
only one of the contestants in the plurality of contestants can draft a player; and
the contestants take turns drafting players for their teams.

15. The system in claim 11 wherein:
each player in the plurality of potential draft picks has a salary; and
each contestant in the plurality of contestants has a salary cap under which the salaries of the players on that contestant's team must fit.

16. The system in claim 11 wherein:
each of the sporting games in the plurality of sporting games in the selected contest is scheduled to be played within a short time period.

17. The system in claim 16 wherein:
the short time period is a single day.

18. The system in claim 11 wherein:
the plurality of sporting games in the selected contest are each a same one of a set comprising: football, baseball, basketball, ice hockey, soccer, NASCAR, rugby, golf, and tennis.

19. The system in claim 11 wherein:
the memory further contains instructions for:
collecting an entry fee from each of the contestants in the selected contest; and
the winner is awarded a prize comprising at least one of a predetermined number of points and a predetermined amount of money for winning the selected contest.

20. The system in claim 11 wherein:
calculating results for each of the contestants includes determining how many points each of the players on each of the teams scored in the plurality of sporting games.
